(19) United States
(12) Patent Application Publication
(10) Pub. No.: US 2007/0278153 A1
(43) Pub. Date: Dec. 6, 2007

(54) Forward osmosis utilizing a controllable osmotic agent

(75) Inventors: Timothy Lewis Oriard, Issaquah, WA (US); Peter Dale Haggerty, Mercer Island, WA (US)

Correspondence Address: GRAYBEAL, JACKSON, HALEY LLP, 155 - 108TH AVENUE NE, SUITE 350, BELLEVUE, WA, 98004-5973, US

(73) Assignee: Cascade Designs, Inc.

(21) Appl. No.: 11/796,118

(22) Filed: Apr. 25, 2007

Related U.S. Application Data
(63) Continuation of application No. PCT/US05/38527, filed on Oct. 25, 2005.
(60) Provisional application No. 60/622,148, filed on Oct. 25, 2004.

(51) Int. Cl. B01D 61/04; B01D 61/08

(52) U.S. Cl. 210/637; 210/205; 210/206; 210/209; 210/639

(57) ABSTRACT

Forward osmosis methods and apparatus using a controllable osmotic agent to establish or enhance an osmotic forward bias are disclosed. In a conventional osmosis environment, a controllable osmotic agent is selectively added to an effluent to establish or enhance an osmotic imbalance that favors transfer of an influent solvent to the effluent. After desirable transfer of the influent solvent to the effluent, the controllable osmotic agent is isolated, removed or neutralized so that the transferred solvent and/or concentrated influent can be recovered. The controllable osmotic agent comprises a composition that is reactive to an external influence that does not appreciably affect the effluent solvent, for example, magnetic forces, electrical charges and filtration. Batch and continuous process methods and apparatus are also disclosed.

### BACKGROUND OF THE INVENTION

1. Field of the Invention

The invention pertains to the field of fluid transport using at least, in part, osmotic pressure as a driving force.

2. Background

The use of semi-permeable membranes as a separation barrier between two solutions not in osmotic equilibrium is well known, and was first described in the French scientific literature in the mid 1700's. Such membranes permit passage of a solution's solvent but not its solute. A starting solution to be treated/filtered consisting of a certain solute molality is considered the influent. An ending solution after treatment/filtration consisting of a certain solute molality is considered the effluent. An osmotic differential between the two solutions exists when the molality of the effluent is different from that of the influent. To create a forward osmotic bias for the influent solvent, the effluent solute molality or osmotic potential must be greater than the influent solute molality or osmotic potential.

Molality refers to the number of solute molecules per liter of solution. In general, the greater the number of solute molecules in a solution, the greater is its osmotic pressure as compared to a solution lacking that solute. This solute differential creates an osmotic imbalance and natural forces of osmotic pressure drive solvent across a semi-permeable membrane separating the influent from the effluent until an osmotic equilibrium is reached between the two solutions. Take for example an influent that is fresh water and an effluent that is sea water; the solute is sea salt and the solvent is fresh water. Because the effluent has a higher molality of solute, fresh water will pass through the membrane to the effluent until an osmotic balance is reached.

Notwithstanding the foregoing example, most operations seek to obtain an effluent that is “cleaner” than the influent. In the example above, the effluent becomes “watered down” sea water, which is generally not considered an advantageous process end product. Under general conditions, it is desired to separate the influent solvent from the solution.

Reverse osmosis accomplishes this objective by forcibly attempting to pass a solute-containing solution across a semi-permeable membrane whereby the membrane “filters” out the solute (e.g., sea salt, etc.) and passes the solvent to create solvent-only effluent (e.g., fresh water). However, reverse osmosis has a host of deficiencies including high energy requirements, membrane integrity during use and storage, and complexity.

In order for forward osmosis to work, the effluent must have a solute molality or osmotic potential greater than the solute molality or osmotic potential of the influent. Problematically, however, the effluent is often fresh water (a common solvent) of exceptionally low solute molality. One solution used in prior efforts has been to benignly increase the effluent solute molality through the introduction of beneficial solutes such as carbohydrates and electrolytes. Thus, while accomplishing an objective of forward osmosis, e.g., the creation of potable water from non-potable water without the deficiencies of reverse osmosis, the effluent is not substantially pure, fresh water; it still contains the solute adjuncts or osmotic by-products.

The concept of forward or direct osmosis as a practical commercial process has been recognized since at least the 1930's. See, for example, U.S. Pat. No. 2,116,920. This patent discloses the use of a concentrated sugar and CaCl₂ aqueous solution to “pull” water out of fruit juices. The general process has been in continuous commercial use to manufacture fruit juice concentrates since at least that time.

The concept of a removable “driving solute” in forward osmosis driven separation is articulated by Charles Moody in his 1977 dissertation. He outlines the use of dissolved SO₂ as an osmotic agent that would increase an effluent's molality above that of sea water, thereby creating a forward osmotic bias that would cause fresh water migration through a semi-permeable membrane from a sea water influent. The SO₂ would then be removed from the effluent by increasing the effluent temperature to drive it out as a gas. To the inventors' knowledge, this process has never been commercially replicated, presumably because SO₂ forms sulfurous acid, which would be highly corrosive to membranes and other process equipment. Additionally, the scheme requires the energy intensive steps of heating and cooling all of the permeated water.

In U.S. Pat. No. 3,617,547, Albert Halff and Allen Reid use an approach similar to that of U.S. Pat. No. 6,391,205. In both cases, an osmotic agent composed of salts, whose solubility is very temperature dependent, is used to increase an effluent's molality above that of sea water, thereby creating a forward osmotic bias that would cause fresh water migration through a semi-permeable membrane from a sea water influent. The osmotic agent is removed by lowering the solution temperature to precipitate the solute out of solution. The precipitate is removed, re-dissolved in water aided by heating and then recycled. The water obtained from the filtered precipitate solution could be further purified, or used as is. These processes are encumbered by the energy inefficient need to chill all of the permeate and recycle streams, as well as the need to reheat the recycle.

Keith Lampi et aL. in U.S. Pat. No. 6,849,184 describe a novel approach of obtaining fresh water from impure or sea water by a combination of forward osmosis and reverse osmosis. Salt and sea water are introduced into a chamber with two semi permeable membranes and then sealed; the introduced solution, therefore, has a molality greater in comparison to that of ordinary sea water. Ordinary sea water is then exposed to a first one of the two semi permeable membranes, which causes the sea water solvent, i.e., fresh water, to cross the first membrane. As the fresh water passes through the first membrane and into the sealed chamber, the internal pressure of the sealed chamber increases. The container is constructed such that the second membrane is in a zone of the sealed chamber still containing sea water largely unmixed with the introduced salt. As the sealed chamber internal pressure increases beyond the osmotic pressure of sea water, fresh water solvent is forced through the second membrane via reverse osmosis. The salt/sea water solution in the sealed chamber would then be discarded. Although possibly practical as a survival device, this invention requires the continuous re-supply of salt or highly concentrated salt solution and is not amenable to a continuous process approach.

In view of the foregoing, it is desirable to have a forward osmosis process and related apparatus that produces an effluent having a solute concentration less than the concentration used during the osmotic process. It is also desirable to reduce or eliminate to the thermodynamic limit the energy requirements associated with obtaining a usable effluent solvent: in true forward osmosis, according to the prior art, the energy expenditure for production of a usable effluent solvent occurs in the solute separation step. Thus, an energy consumption improvement over prior art forward osmosis will occur at this phase of the process, and ideally any such step will direct energy expenditure to only the solute, as opposed to acting on the entire effluent solution.

### SUMMARY OF THE INVENTION

The invention is directed to forward osmosis methods and apparatus employing at least one controllable osmotic agent. Basic apparatus embodying the invention comprise at least one semi-permeable hydrophilic or hydrophobic membrane as a separation barrier between a first fluid solution (influent), comprising a first solvent, and a second fluid solution (effluent) comprising a second solvent. To create a forward osmotic bias from the influent to the effluent, apparatus embodying the invention comprise at least one controllable osmotic agent added to the effluent to create an osmotic imbalance that favors migration of the first fluid solution solvent to the second fluid solution. The resulting osmotic imbalance permits the natural forces of osmotic pressure to drive the first solvent of the influent across the at least one semi-permeable membrane into the effluent until an osmotic equilibrium is reached between the two fluid solutions or the supply of influent ceases. Basic apparatus according to the invention may further comprise means for isolating, removing or neutralizing the at least one controllable osmotic agent from the effluent.

Additional apparatus embodiments according to the invention may further comprise means for recovering the at least one controllable osmotic agent after isolation and/or removal from the effluent, and may further comprise means for reintroducing the recovered at least one controllable osmotic agent into the effluent, operatively proximate to the at least one semi-permeable membrane, to re-establish or otherwise contribute to the osmotic imbalance necessary for establishing a forward osmotic bias.

Basic methods embodying the invention comprise isolating a first fluid solution (influent) having a first solvent from a second fluid solution (effluent) having a second solvent with at least one semi-permeable hydrophilic or hydrophobic membrane; introducing at least one controllable osmotic agent to the effluent in sufficient amounts to create an osmotic imbalance between the influent and the effluent; and permitting solvent from the influent to pass through the at least one semi-permeable membrane to the effluent. Further methods according to the invention comprise partially or substantially wholly isolating, removing or neutralizing the at least one controllable osmotic agent in the effluent.

Additional methods embodying the invention may comprise recovering the at least one controllable osmotic agent after isolation and/or removal from the effluent, and may further comprise reintroducing the recovered at least one controllable osmotic agent into the effluent operatively proximate to the at least one semi-permeable membrane to re-establish or otherwise contribute to the osmotic imbalance necessary for establishing a forward osmotic bias.

A component of the methods and apparatus disclosed herein is a controllable osmotic agent. As used herein, the term “controllable osmotic agent” is defined as a substance that alters the osmotic potential between a first fluid solution exposed to one side of a solvent semi-permeable membrane, and a second fluid solution exposed to the other side of the membrane, where the influence of the substance on the osmotic potential across the membrane can be manipulated. Thus, a controllable osmotic agent according to the invention is one that a) dissolves, or is suspendable in the second fluid solution such that it is able to establish or enhance an osmotic driving force across the membrane relative to the first fluid solution exposed to the other side of the membrane; and b) possesses at least one chemical or physical property, or combination of the two, that allows for it's removal, neutralization or separation from the second fluid solution by means that do not appreciably affect the solvent of the second fluid solution. Thus, candidate controllable osmotic agents do not intrinsically rely upon pressure or temperature changes of the second fluid solution solvent for removal, neutralization or separation of the agent therefrom.

While many contemplated controllable osmotic agents function as solutes (ionic compounds and small dissolved molecules) within the second fluid solution solvent, this characteristic is not necessary to the functionality of embodiments of the invention. The invention is also operative through the use of large molecules within the second fluid solution to establish or enhance the forward osmotic bias. Macromolecules, with a large number of surface charges either positive, negative or combinations thereof, exert a significant osmotic pressure, because the charge in the solution is of high molality, and are therefore considered appropriate controllable osmotic agents both from the perspective of establishing or enhancing the forward osmotic bias as well as being susceptible to removal, neutralization or separation from the second fluid solution without use of pressure or temperature techniques.

A controllable osmotic agent present in many embodiments of the invention is one that is responsive to magnetic forces and/or electric fields, allowing it to be magnetically and/or electrically influenced, and thus separated from the second fluid through standard magnetic separation techniques that otherwise have no appreciable effect on the second fluid solution solvent. Other examples include, but are not limited to, osmotic agents that are removed/reduced through filtration, chemical precipitation, chelation, oxidation/reduction reactions, distillation, evaporation, pressure adjustments/manipulations, temperature adjustments/manipulations, electrochemical means, capacitive deionization and other means known to those skilled in the art.

A feature of the invention is its ability to dilute or concentrate a fluid solution. As referenced above, embodiments of the invention establish or enhance a forward osmosis bias by utilizing one, or a combination, of controllable osmotic agents that are added to the effluent or second fluid solution. Once enough influent solvent has passed through the at least one semi-permeable membrane to the effluent to satisfy target solution requirements, the osmotic agent(s) can be removed, reduced and/or neutralized to desired levels for a finished influent or effluent solution. Either the influent or effluent may represent the desired final solution. In the case of obtaining drinking water from a non-potable water source, the effluent is modified such that substantially all the non-desirable controllable osmotic agent(s) is/are removed. In the case of concentrating, for example, fruit juices or process solutions, the influent is recovered at a desired point while the effluent represents a convenient, non-thermal concentrator. The agent(s) introduced into the effluent to drive the process can be recovered or simply disposed of depending upon any identified use for the effluent.

The use of at least one controllable osmotic agent to create or enhance an osmotic driving force is not exclusive. It may be used in conjunction with other osmotic pressure enhancement compositions and/or methods, such as adding pressure to an influent, increasing the trans-membrane flux rate such as by increasing the area of the membrane, or by altering the influent's chemistry through precipitation, chelation, pH adjustments, sequestering agents, cleaning and anti-fouling agents, temperature alterations, and other means known to those skilled in the art.

In view of the preceding paragraph, a variation of the first embodiment involves a partial, as opposed to a substantially complete, removal and/or neutralization of the solute(s) and/or controllable osmotic agent(s) present in the effluent. For example, circumstances may arise where it is desired to leave a certain amount of solute in the effluent. One example would be desalinating sea water or brackish ground water for crop irrigation. Both fertilizer (solute) and (a) controllable osmotic agent(s) can be added to the effluent to make a combined high molality effluent solution as compared to the water-solvent containing influent, thereby establishing or enhancing an osmotic bias towards the effluent. Once the effluent reaches its desired water concentration level, the controllable osmotic agent(s) can be removed and/or neutralized while leaving the fertilizer in the effluent (irrigation water). A similar process can be used with respect to creating drinking water from a non-potable water source where dissolved nutrients in the effluent take the place of fertilizer.

In embodiments that utilize magnetic or electro-chemically controllable osmotic agent(s), it's not the agent's solubility per se that is being controlled, but rather its presence is being controlled more by the physical processes of electrochemistry and/or magnetism. One series of embodiments use a controlled osmotic agent comprising magnetite bound to a protein such as ferritin, producing a substance known as Magnetoferritin. Such a substance is available, for example, from NanoMagnetics, Ltd. of Bristol, UK. NanoMagnetics' Magnetoferritin are magnetic particles surrounded by uniform hollow protein spheres that are about 12 nm in diameter. Beneficially, these protein spheres are water soluble, thereby having appropriate attributes to act as a solute in aqueous solutions. By having a convenient and conventional means for actively transporting a solution's solute, one has the ability to use a stronger dose (concentration of osmotic agent) to thereby increase osmotic flux while being entirely removable from the effluent without complicated chemical processes or significant resources such as filtration. Furthermore, this form of controllable osmotic agent is wholly recyclable and biodegradable.

Many other combinations of an inorganic magnetic substance combined with another organic or inorganic carrier substance, such that the whole can be removed by magnetic or electrochemical means, are possible and are hereby included in this invention. Thus, carrier substances such as colloidal lipid particles or shells can be employed to carry a magnetic or magnetically reactive payload, and desirably possess low solvent dissolution characteristics to assist in solute recovery and reuse.

The methods disclosed herein can be serially employed in a multiple stage process similar to multi-stage distillation and other multiple stage examples known to those skilled in the art: the effluent from one operation can become the influent to a subsequent operation and so on. In addition, the invention also lends itself to either batch or continuous processes, examples of which include a filtration membrane bag (batch) or a spiral wound or hollow fiber membrane cartridge run in a continuous fashion.

While the described methods find broad utility in nearly all applications that require high solvent concentrations in the effluent, the invention finds particular utility for those applications where conventional reverse osmosis has disadvantages. For example, recovery of potable, unadulterated water from sea water or brackish water where little or no electricity is available, or where spare parts for a reverse osmosis apparatus are not available will exemplify environments where the invention will find particular utility over the prior art. Such environments can be found in remote land-based locations, transoceanic passages by sailboat, or personal mountaineering. In each of these environments, power resources may be limited as well as parts availability.

### BRIEF DESCRIPTION OF THE DRAWINGS

FIGS. 1 a-c depict a batch embodiment of the invention for the purification of water in the field;

FIG. 2 is a schematic process flow diagram for a continuous process for the purification of water or desalination of sea water;

FIG. 3 is a schematic process flow diagram for a multi-staged process for the desalination of sea water or the purification of water;

FIGS. 4a and 4b schematically illustrate the use of a magnet or an electromagnet to localize magnetically responsive osmotic agents in close proximity to a semi permeable membrane; and

FIGS. 5a and 5b schematically illustrate the use of an electric field to localize electric field responsive osmotic agents in close proximity to a semi-permeable membrane.

### DESCRIPTION OF THE EMBODIMENTS

The following discussion is presented to enable a person skilled in the art to make and use the invention. Various modifications to the described embodiment will be readily apparent to those skilled in the art, and the generic principles herein may be applied to other embodiments and applications without departing from the spirit and scope of the present invention as defined by the appended claims. Thus, the present invention is not intended to be limited to the embodiment shown, but is to be accorded the widest scope consistent with the principles and features disclosed herein.

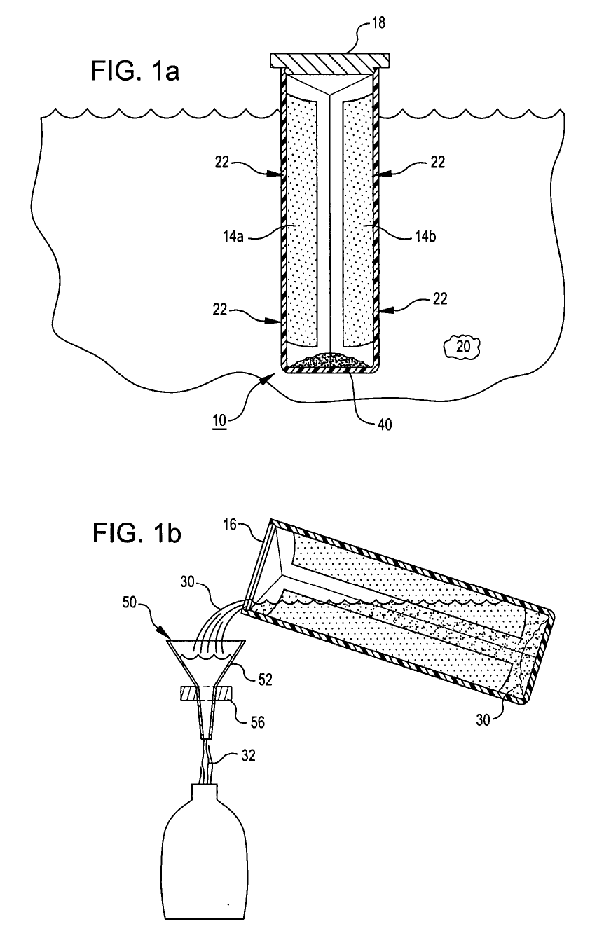

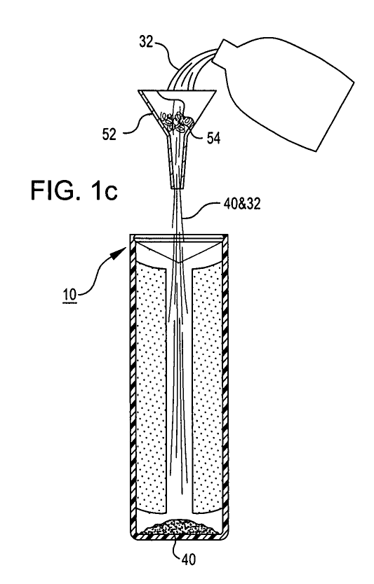

Referring first to FIGS. 1a-c, wherein like numerals indicate like parts, a simple “batch” embodiment of the invention to provide potable, unadulterated water that is easily and inexpensively created will now be described. Sealable plastic bag 10 is preferably constructed of food grade polyurethane with dimensions of approximately 12 inches tall by 10 inches wide by ⅛ inch thick (similar in size, shape and spirit to typical medical intravenous drip bags). Formed on opposing sides of bag 10 is a pair of “windows”, having dimensions of approximately 10 inches tall by 8 inches wide. Skilled practitioners will readily agree that by maximizing the surface area of a semi-permeable membrane between an influent and an effluent, osmotic flux is maximized; thus, two semi-permeable membranes 14a and 14b are used. Each membrane 14 is a 10.25 inch by 8.25 inch flat sheet of asymmetric hydrophilic cellulose acetate nano-filtration membrane (obtained from Hydration Technologies, Inc. of Albany, Oreg.). Each membrane 14 is preferably attached to the inside surface of bag 10 with a 0.125 inch overlap seam, secured through standard means known to those skilled in the art including chemical adhesion or RF welding. Those persons skilled in the art will appreciate that any such ported and windowed fluid reservoir will be sufficient to carry the objectives of the invention.

Additionally, through RF welding or similar process, pour spout 16 is added to the top seam of the plastic bag, allowing a direct opening from the environment to the interior of bag 10. Again, the skilled practitioner will appreciate that any access port, preferably sealable but not necessarily so, sufficient to gain access to the interior of bag 10 will meet this requirement. Introduced into bag 10 and through pour spout 16 is 200 grams of a protein/nanomagnetic complex of particles such as dried, powdered Magnetoferritin supplied by Nanomagnetics, Bristol, UK. Screw cap 18 is then tightened down, cutting off direct access of fluids to the interior of bag 10. Any fluids must now enter the interior of bag 10 only by permeating through semi-permeable membranes 14a and 14b in bag 10, once bag 10 is placed into a source of water (or other fluid) that is to be treated by filtration.

The prepared bag 10 is then placed into a source of influent 20, which in this example is a pond near a campsite with a total dissolved solids level of 1000 mg/L, a total suspended solids level of 2000 mg/L, a bacterial count of 3000 CFU/L and a protozoa count of 50 Cryptosporidium oocysts per liter. When bag 10 is submersed into influent 20, hydrophilic membranes 14a and 14b allow enough influent solvent 22, i.e., water, to dissolve into the interior of bag 10 to begin to wet out and dissolve Magnetoferritin particles 40. As concentrated Magnetoferritin effluent solution 30 begins to form, it causes an increased osmotic potential difference across semi-permeable membranes 14, thereby causing an increased flux rate of influent solvent 22 across membranes 14. The flux rate will peak, when the last of the Magnetoferritin particles 40 dissolve into solution, then will gradually and steadily slow as Magnetoferritin containing effluent solution 30 is steadily diluted by incoming water, thus lowering its osmotic potential. Based upon these parameters, a one liter bag will fill in about 8 to 10 hours, depending on temperature and pH of the influent. The membrane will have filtered substantially all of the bacteria, Cryptosporidium, total suspended solids, and 70% to 95% of the total dissolved solids, rendering the pond water sufficiently safe to drink.

Turning next to FIG. 1b, once bag 10 is filled with filtered water, the user removes it from the pond, exposes pour spout 16 and pours effluent solution 30 slowly through magnetic separator 50 that comes with it, into a drinking water containment reservoir. Magnetic separator 50 comprises open funnel 52 that is packed with easily magnetized metal fiber “wool” 54, similar to steel wool or a ferrous metal powder. A powerful handheld permanent magnet, such as a neodymium ferric boron magnet from Ana International, Inc., Portland, Oreg., is brought into very close physical proximity to metal wool 54, e.g., funnel 52 is set down into “donut” shaped ring magnet 56, magnetizing metal wool 54. As Magnetoferritin-containing effluent solution 30 is poured through separator funnel 50, Magnetoferritin particles 40 are attracted to magnetized metal wool 54 and attach to it, effectively separating substantially all Magnetoferritin particles 40 from final effluent solution 32, leaving only clear, filtered, safe drinking water.

The option is available, if desired, to reuse Magnetoferritin particles 40 numerous times. Once magnet 56 is physically removed from the immediate vicinity of separator funnel 52 and metal wool 54, Magnetoferritin particles 40 are free to dissociate from metal wool 54 and are available to be reused. This is accomplished by pouring a very small quantity of final effluent solution 32 into separator funnel 52, over metal wool 54, flushing off Magnetoferritin particles 40, as shown in FIG. 1c. The particles can be washed back into bag 10 for reuse, into a new bag, or simply collected for later reuse.

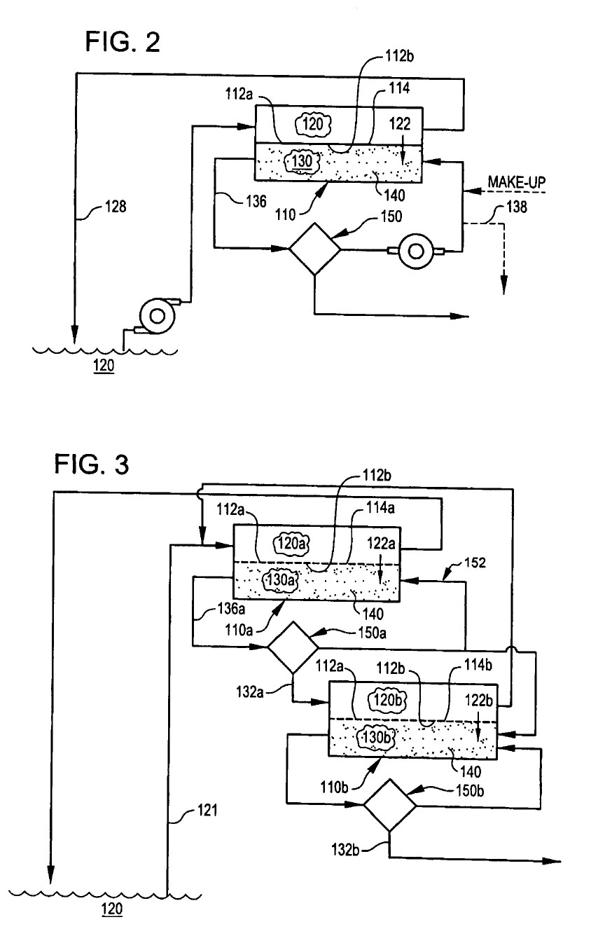

Another embodiment is a continuous process, as shown schematically in FIG. 2. Sea water, contaminated water, and other forms of influent solutions to be purified are represented as feed water 120, which is supplied to the process. Feed water 120 is filtered (not shown), and enters forward osmosis (FO) unit 110. FO unit 110 preferably includes semi-permeable membrane 114. Also entering FO unit 110, on side 112b of membrane 114, is effluent solution 130, comprising a high concentration of Magnetoferritin particles 140. Magnetoferritin particles 140 are surface charged enough and at high enough concentration such that the osmotic potential of effluent solution 130 is higher than that of feed water 120. As those persons skilled in the art will appreciate, FO unit 110 could be any one of a number of design configurations, including but not limited to, spiral wound, hollow fiber, or flat sheet.

Water 122 (the influent's solvent) passes through membrane 114 into effluent solution 130, which continues to have a higher osmotic potential than feed water 120. The resulting diluted Magnetoferritin solution 136 then moves by gravity or mechanical assist to magnetic separator 150. Here, Magnetoferritin particles 140 are concentrated and recycled 142. Makeup solute can be fed into the system at this time. Also, it may occasionally be desirable to purge all or part of effluent solution 130 via line 138. Meanwhile, concentrated feed water can be returned to the ocean via line 128. Regardless of the process recoveries, final effluent solution 132 leaves magnetic separator 150 for sale or use.

In cases where the feed water solute concentration (molality) is too high, or where the Magnetoferritin particles are not sufficiently surface charged to overcome the osmotic potential of the feed water, the process may be staged as shown in FIG. 3. As described above, feed water 120 (first influent) enters first FO unit 110a where it is exposed to first semi-permeable membrane 114a. First effluent 130a, on the opposite side of membrane 114a, is comprised of water (solvent), a controllable osmotic agent, such as Magnetoferritin particles 140, and a “non-removable” solute, such as sea salt. As before, first effluent solution 130a becomes diluted by water 122a diffusing through membrane 114a. A partially purified solution 132a can be obtained by passing first effluent solution 130a through first magnetic separator 150a, where Magnetoferritin particles 140 are substantially removed as previously described; partially purified solution 132a is then fed to second FO unit 110b where it becomes second influent 120b. Magnetoferritin particles 140 leaving first magnetic separator 150a are preferably recycled through line 152 to first FO unit 110a. First influent 120a, leaving first FO unit 110a, may be recycled through line 116 to feed water stream 121, provided its salt (solute) concentration is at least as low as that in feed water 120a. If the solute concentration in line 116 is greater than in the feed water stream 121, it is discarded.

Partially purified solution 132a from first magnetic separator 150a, having been fed to second FO unit 110b, is concentrated and the concentrated solution becomes second influent 120b. Second effluent 130b from second FO unit 110b is purified to remove Magnetoferritin particles 140, and may be recycled as second influent 120b to second FO unit 110b. Purified water 132b exits second magnetic separator 150b, and is ready for use. Thus, any number of purification stages can be used in the process as needed in order to achieve a final effluent solution of the desired purity.

As the skilled practitioner will appreciate, concentration polarization becomes a limiting factor in either forward osmosis or in reverse osmosis. Essentially, the boundary layer adjacent to the semi-permeable membrane becomes too concentrated in solute on the influent side and too diluted with driving solvent on the effluent side, thereby adversely affecting the forward osmotic driving force. High fluid velocities and mixing are usually used to mitigate this inherent problem.

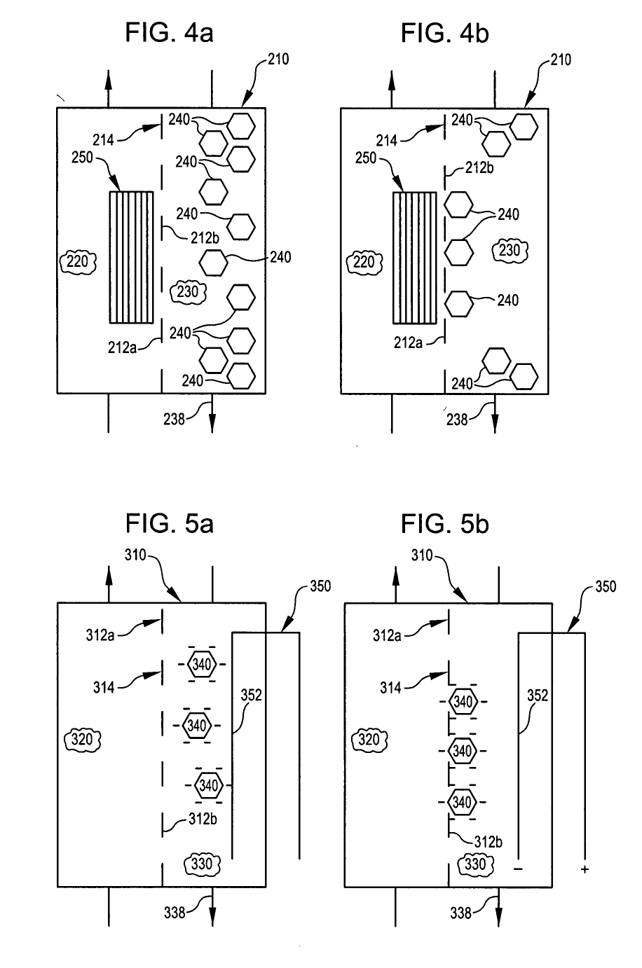

To address this problem, the controllable osmotic agent separation process may be placed in very close proximity to the membrane, thereby increasing the localized concentration of the controllable osmotic agent adjacent to the membrane. FIG. 4a shows electromagnet 250 placed in close proximity to semi-permeable membrane 214 on influent side 212a of FO unit 210. Magnetoferritin particles 240, or other magnetically responsive osmotic driving substance, are shown after some dilution near membrane 214. In FIG. 4b, a magnetic field has been established at electromagnet 250, pulling Magnetoferritin particles 240 closer to membrane 214 and increasing its local concentration, thus helping to increase the rate of trans-membrane diffusion. Additionally, effluent 230 on effluent side 212b has Magnetoferritin particles 240 removed from it, at least in part, and so at least a partial separation process is preformed. Electromagnet 250 can be energized intermittently, so as to dewater the Magnetoferritin particles in pulses. Effluent stream 238 may now pass to another magnetic separator for additional Magnetoferritin particle removal “polishing,” or to be used as is.

Since the Magnetoferritin particles have a charged surface (negative), an electric field can be used analogously as a separation means to the above embodiment. FIG. 5a shows uncharged electrode 350 placed on effluent side 312b of FO unit 310. Again, Magnetoferritin particles 340 (shown here with negative charge) are normally diluted in the region of membrane 314. In FIG. 5b, a negative charge is developed at electrode 352, forcing Magnetoferritin particles 140 toward membrane 314, thereby increasing local concentration. As a consequence of this localized concentration, the osmotic driving force increases and the permeate bulk flow becomes purer. In a further refinement, the electrode is pulsed on when the membrane boundary layer concentration gets too low, as may be discerned through the use of an appropriate sensor. Also, as before, this embodiment could be used in conjunction with another separation step; either magnetic, electric or physical filtration.

What is claimed:

1. A method for producing a purified effluent solution or concentrating an influent solution, comprising:
isolating a first fluid solution comprising a first solvent from a second fluid solution comprising a second solvent with at least one semi-permeable membrane;
introducing at least one controllable osmotic agent to the second fluid solution in sufficient amounts to create an osmotic imbalance between the first and the second fluid solutions that favors migration of the first solution solvent to the second fluid solution; and
permitting solvent from the first solution to pass through the at least one semi-permeable membrane to the second solution.

2. The method of claim 1 further comprising at least partially isolating the controllable osmotic agent in the second solution solvent to permit recovery of the second solution solvent substantially free of the controllable osmotic agent.

3. The method of claim 1 further comprising at least partially removing the controllable osmotic agent in the second solution solvent to permit recovery of the second solution solvent substantially free of the controllable osmotic agent.4.

4. The method of claim 1 further comprising at least partially neutralizing the controllable osmotic agent in the second solution solvent to permit recovery of the second solution solvent substantially free of the controllable osmotic agent.

5. The method of claim 3 further comprising recovering at least part of the second solution solvent, and reintroducing at least a portion of the removed controllable osmotic agent into at least that portion of the second solution solvent that remains.

6. The method of claim 1 further comprising adding a second osmotic agent to the second solution to increase the osmotic flux rate through the at least one semi-permeable membrane.

7. The method of claim 6 wherein the second osmotic agent is a desired second solution solute and the controllable osmotic agent is substantially removed from the second solution prior to recovery of the second solution solvent.

8. The method of claim 1 further comprising one of introducing an osmotic pressure enhancement composition or engaging in an osmotic pressure enhancement method.

9. The method of claim 1 further comprising repeatedly at least partially removing the controllable osmotic agent in the second solution solvent, recovering at least a portion the second solution solvent substantially free of the controllable osmotic agent, and reintroducing at least a portion of the removed controllable osmotic agent into at least that portion of the second solution solvent that remains.

10. The method of claim 1 where the controllable osmotic agent is reactive to at least one of magnetic forces, electrical charge, or filtration.

11. An apparatus for producing a purified effluent solution or concentrating an influent solution, comprising:
a first fluid reservoir defining an interior space comprising at least one membrane, between the interior space and the environment, that is semi-permeable to a first fluid solution solvent; and
a controllable osmotic agent within the interior space, whereby upon exposure to the at least one membrane, the first fluid solution solvent will pass through the at least one membrane and establish, in conjunction with the at least one controllable osmotic agent, a second fluid solution.

12. The apparatus of claim 11 whereby a forward osmotic bias from the first fluid solution to the second fluid solution is established prior to the first and second fluid solutions reaching an osmotic equilibrium.

13. The apparatus of claim 11 wherein the first fluid reservoir is sealable to facilitate batch transfer of the first fluid solution solvent.

14. The apparatus of claim 11 wherein the first fluid reservoir has at least one discharge port to facilitate continuous transfer of the first fluid solution solvent during operation of the apparatus.

15. The apparatus of claim 11 further comprising means for one of isolating, removing or neutralizing the controllable osmotic agent.

16. The apparatus of claim 15 further comprising means for recovering at least part of the second solution solvent, and means for reintroducing at least a portion of the removed controllable osmotic agent into at least that portion of the second solution solvent that remains.

17. The apparatus of claim 11 further comprising a second osmotic agent within the interior space to increase the osmotic flux rate through the at least one semi-permeable membrane during operation of the apparatus.

18. The apparatus of claim 11 further comprising one of means for introducing an osmotic pressure enhancement composition or means for engaging in an osmotic pressure enhancement method.

19. The apparatus of claim 11 further comprising a filter element.

20. The apparatus of claim 11 where the controllable osmotic agent is reactive to at least one of magnetic forces, electrical charge or filtration.
